(19) United States
(12) Patent Application Publication
(10) Pub. No.: US 2026/0129267 A1
(43) Pub. Date: May 7, 2026

(54) Automated Video Generator with eCommerce Listings

(71) Applicant: Fluzit, LLC, Albuquerque, NM (US)

(72) Inventors: Carl Vidal, JR., Albuquerque, NM (US); Gregory Mullen, Rio Rancho, NM (US)

(73) Assignee: Fluzit, LLC, Albuquerque, NM (US)

(21) Appl. No.: 18/935,443

(22) Filed: Nov. 2, 2024

(51) Int. Cl. H04N 21/81; G06Q 30/0241; G06Q 30/0601

(52) U.S. Cl. CPC H04N 21/812; G06Q 30/0276; G06Q 30/0277; G06Q 30/0601; H04N 21/8113

(57) ABSTRACT

A method for enhanced, automated ecommerce listings for products or services with associated marketing information and mixed-media advertisements that requires minimal human input.

### BACKGROUND/SUMMARY

### BACKGROUND OF THE INVENTION

The present patent application relates to methods, devices, and systems for electronic marketing of products and services.

In one aspect, a method for creating a product or service listing and subsequent video content is disclosed. Products and services (deliverable) are commonly sold on the internet which require listings with the applicable product or service information such that a customer can understand the product or service offered. The more details for the product or service that are provided, the better a potential customer can understand the product or service. Sophisticated, and appealing advertisements for the products and services such as videos with combined visual, audio, and textual content are more likely to entice customers to purchase.

Automation of this process reduces the time to provide extensive detail with higher quality videos allowing for faster listing of content enabling the handling the larger volume of listings without a proportional increase in manual labor. Consistency among listings from a seller is established. Risk of listings being removed or penalized due to Marketplace policy violations is decreased by introducing compliance checks at the generation stage. Unlike traditional methods, where a human must create or prompt an AI to generate each component of a listing, including an SEO-friendly title and persuasive description, this invention autonomously composes all elements of the listing. It draws from available images and data to ensure accuracy, sales appeal, and search visibility, eliminating the need for human expertise in crafting market-facing content. This method accelerates listing creation, enhances consistency, and ensures compliance with marketplace requirements.

In traditional ecommerce listing creation, human creators are responsible for not only gathering and inputting detailed product information but also crafting each component with sales and search optimization in mind. Titles, descriptions, and images require both accuracy and marketing-savvy language to appeal to potential buyers.

Even with AI-assisted tools, the process typically requires a human to prompt the AI for each part of the listing (such as the title, description, and bullet points) and to revise the content for quality, consistency, and compliance with marketplace policies. This dependence on human skill in marketing and SEO copy slows the listing process and can result in inconsistencies across listings, particularly in larger inventories.

### SUMMARY OF THE INVENTION

It is an object of this patent to describe a method for the automation of creating sales listings on the internet, source marketing information, and automate creation of videos from sourced data.

### DESCRIPTION

### BRIEF DESCRIPTION OF THE DRAWINGS

FIG. 1 is a flow diagram illustrating a process for creating product listings.

FIG. 2 is a flow diagram illustrating a process for creating videos from sourced data.

### DETAILED DESCRIPTION

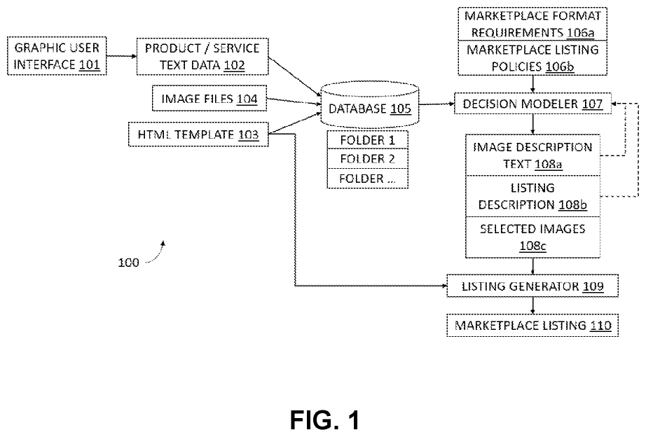

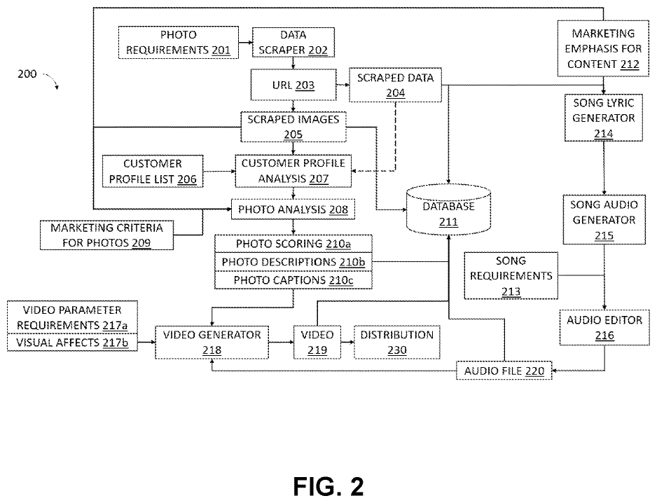

Marketplace listings 110 are published on website URLs by the process 100 depicted in FIG. 1. These listings may be subsequently used in process 200 depicted in FIG. 2 to create video content 219 for the listings. Any product or service can potentially benefit from the provided listing and advertising method.

A user interface 101 typically in the form of a graphic user interface (GUI) is used to input known information 102 about the deliverable which may include any information that would be beneficial to a potential customer for understanding of the deliverable. Example information includes but is not limited to: specifications, sizes, weight, format, location, cost, history, condition, and characteristics. This information 102 along with an HTML template 103 and image files 104 of the deliverable is stored in an electronic database 105.

The database 105 is configured with one or more folders with content for each deliverable stored in a different folder. While various formats may be used for the documentation of the text data 102 within the database 105, an efficient format is a single CSV file with all text in a single row and the type of data separated in rows. The files within each folder of the database 105 are processed by a decision modeler 107. This can be performed in serial or in parallel to reduce time with multiple deliverables.

Additional information may be provided to the decision modeler 107 to further improve deliverable listings. When using third party marketplaces with specific requirements for format of listings or policies that must be adhered to, these format requirements 106a and listing policies 106b may be provided to the decision modeler 107. Some marketplaces provide options for type of sale such as an auction or immediate purchase at a fixed price. Dictating the desired sale type may be an optional input. After the initial input from a technician, the system autonomously completes all tasks without requiring further human interaction.

The decision modeler 107 creates and outputs image descriptions 108a by identifying all clearly visible data from the images 104 including but not limited to: deliverable type, text, features, colors, information from data labels, and visual appearance. Descriptions 108a are directed to exclude any redacted information on the deliverable and any information that would not adhere to provided policies 106b. Listing descriptions can also be created based on the image descriptions 108a created and the deliverable data 102. The listing description 108b is the textual information that will be provided in the marketplace listing. The image descriptions 108a and listing descriptions 108b may be iterated through the decision modeler 107 to perform checks against the format requirements 106a and listing policies 106b. Any error that cannot be resolved by the decision modeler 107 may be flagged to the user to resolve. Additionally, the decision modeler 107 outputs selected images 108c from the input image files 104 by evaluating the image descriptions and determining which images to post to the marketplace and which are suitable as a main listing image based in part on clarity and content.

The listing generator 109 populates the HTML template 103 with the image descriptions 108a, listing description 108b, and selected images 108c to create the marketplace listing 110. This typically utilizes a JSON type file populated with this data. The HTML template 103 is ideally pulled from the database 105.

The effects of the automated listing include, in part: time efficiency or reduced labor time especially with large quantities of listings, increased accuracy of listing information, consistency across listings, and verified adherence to marketplace policies.

In a first example embodiment, video 219 content may be created with files sourced from an electronic database. In a second example embodiment, video 219 content is created from data scraped from a website URL such as a marketplace listing. Such listing may be created by process 100, another method, or be a third-party site. Any photo requirements 201 may be provided to the data scraper 202 if desired to narrow the type of photos taken from a website as may be desirable for narrowing the resultant video 219 content. The data scraper 202 is directed to the desired URL 203 and all data 204 along with any photos 205 are copied into an electronic database 211 and provided to a customer profile analysis module 207 where an analysis of the data is performed to determine the type of customer profile which is the most likely potential customer type for the product or service on the scraped URL 203 from a preset customer profile list 206 that is provided to the customer profile analysis module 207. The customer profile list 206 may be formatted as a matrix including ideal customer profiles.

The images 205 are analyzed 208 using the determined customer profile type, any desired marketing emphasis for the video 212, and any desired marketing criteria for the photos 209. Such criteria may include any specific details that are intentionally desired to be included for the target audience. Based on these inputs, the images 205 are scored 210a relative to each other for weighting on whether to include in the final video 219 and how much emphasis the image will be given. Text descriptions 210b of the images are created along with captions 210c for each of the images based on their visual content. This information is provided to the video generator 218. Alternatively, this image information may be first or concurrently be provided to the database 211.

Desirable marketing emphasis information 212 is also provided along with the scraped images 204 to a song lyric generator 214 which uses the text data of the images 204 to develop lyrics for a song that is appropriate to the marketing emphasis 212 for the content. The lyrics 214 are provided to the song audio generator 215 to create the audio file using the provided lyrics 214 and then adjusted for any provided song requirements 213 that may be provided in the audio editor 216. Such song requirements 213 may include, for example; song time length, specific words to include or exclude, genre, composition, tempo, or style. The resulting audio file 220 may be stored in the database 211 and provided to the video generator 218 where it is combined with the provided images 205, photo data 210, any video parameter requirements 217a, and any desired visual effects 217b to compile the data and create a video 219 which may be stored in the database 211, and distributed 230 to marketing locations such as the URL 203 form which the data was originally scraped from or another forum for advertising the deliverable. Video parameter requirements 217a may include, for example; video length, resolution, and file size. Added visual effects 217b may be intentionally or randomly selected to enhance the video appeal with effects such as, for example; fade-in, fade-out, zoom in or out to areas of images, image transition effects, panning, and border types. The video generator 218 analyzes the tempo and beats of the audio 220 to allocate durations for each image 205 as well as applying any zoom and pan effects. Visual effects 217b are applying where the duration of the effect matches the duration of image applied to. Captions 210c should be located on the images 205 such that they are legible and well-positioned in relation to the image considering the image content and color. Captions 210c should be checked against criteria 209 prior to sending to video generator 218 or database 211.

The resulting video 219 including image transitions with captions and song is a beneficial marketing tool that minimizes the labor time by using automation to create effective advertisements for the desired product or service to be offered.

Machine learning modules provide available and efficient means of analyzing data and creation of artistic media such as audio and video files.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

1. A method of creating a product or service ecommerce listing comprising:
product or service information that includes text, images, or both;
an HTML template;
an electronic database;
a decision modeler utilizing machine learning that creates a listing description based on said product or service information;
a listing generator utilizing machine learning that formats said listing description using said HTML template; and
distributes said listing to a directed marketplace website or to said database.

2. The method of claim 1, further comprising a user interface for inputting data pertaining to the product or service.

3. The method of claim 2, wherein said decision modeler also creates description text for said image files.

4. The method of claim 3, wherein said decision modeler also selects images to be published from said provided images.

5. The method of claim 4, further comprising marketplace format requirements provided to said decision modeler.

6. The method of claim 5, further comprising marketplace listing policies provided to said decision modeler.

7. The method of claim 6, further comprising an iterative processing of said listing descriptions or image descriptions through said decision modeler for error checking and refinement.

8. A method of creating a video comprising;
retrieving images and any associated text from an electronic source;
an electronic database;
a photo analyzer utilizing machine learning that reviews said images to provide image scoring, image text descriptions, and image captions, optionally using directed emphasis for marketing or criteria for the images;
a video generator utilizing machine learning that creates videos from the provided images and text; and
distribution of the video either to an electronic database, directed URL, or said URL that said image and text data was scraped from.

9. The method of claim 8, wherein the electronic source is a URL site with information developed by claim 1.

10. The method of claim 9, further comprising the input of video parameter requirements of visual effects to said video generator to constrain the video parameters within directed guidelines or enhance the video for increased viewing enjoyment or advertising effect.

11. The method of claim 10, further comprising a customer profile analysis utilizing machine learning that receives said scraped images, text data, and user provided list of customer profiles to determine the customer profile that best matches the data then providing the customer profile to the photo analysis to further refine the image scoring, image descriptions, and image captions.

12. The method of claim 11, further comprising a list of photo requirements provided to the data scraper by the user to refine the images that are scraped from the designated source.

13. A method of creating a video comprising;
retrieving images and text from an electronic source;
an electronic database;
a song lyric generator utilizing machine learning that creates lyrics from provided text;
a song audio generator utilizing machine learning that creates audio from said song lyrics;
a photo analyzer utilizing machine learning that reviews said images to provide image scoring, image text descriptions, and image captions, optionally using directed emphasis for marketing or criteria for the images;
a video generator utilizing machine learning that creates videos from the provided images, audio and text; and
distribution of the video either to an electronic database, directed URL, or said URL that said image and text data was scraped from.

14. The method of claim 13, wherein the electronic source is a URL site with information developed by claim 1.

15. The method of claim 14 wherein the video generator develops the timing of image transitions, special effects, and timing of captions based on the song parameters wither input to the song generator or developed by the song generator.

16. The method of claim 15, further comprising the input of video parameter requirements of visual effects to said video generator to constrain the video parameters within directed guidelines or enhance the video for increased viewing enjoyment or advertising effect.

17. The method of claim 16, further comprising an audio editor utilizing machine learning that receives said audio file and user provided song requirements to create a modified audio file that meets the requirements provided.

18. The method of claim 17 further comprising a customer profile analysis utilizing machine learning that receives said scraped images, text data, and user provided list of customer profiles to determine the customer profile that best matches the data then providing the customer profile to the photo analysis to further refine the image scoring, image descriptions, and image captions.

19. The method of claim 18, further comprising a list of photo requirements provided to the data scraper by the user to refine the images that are scraped from the designated source.
